(19) United States
(12) Patent Application Publication
(10) Pub. No.: US 2006/0277192 A1
(43) Pub. Date: Dec. 7, 2006

(54) Method of automatic filing of searching results

(75) Inventors: Kuo-Jen Chao, Yongkang City (TW); Tu-Hsin Tsai, Taipei (TW)

Correspondence Address: HDSL, 4331 STEVENS BATTLE LANE, FAIRFAX, VA, 22033, US

(73) Assignee: Tornado Technologies Co., Ltd.

(21) Appl. No.: 11/144,676

(22) Filed: Jun. 6, 2005

(51) Int. Cl. G06F 17/30

(52) U.S. Cl. 707/10

(57) ABSTRACT

A method of automatic filing of searching results includes steps of connecting to internet via electrical products such as computer, cellular phone, PDA, and etc, entering searching engine and keying in keyword of data to be searched, processing search and listing searching results by the searching engine, choosing required data, then automatically downloading the required data and filing it. This method automatically and accurately saves the searching results without user's complex command, and therefore saving time and resource.

### BACKGROUND OF THE INVENTION

1. Field of the Invention

The invention relates a method of automatic filing of searching results, and more particularly to a method of automatic filing of searching results according to a defined rules.

2. Description of Related Art

By the improvement of technology, the scale of Internet is growing. By well applying the useful resources found on Internet, it can bring convenience to a person or a firm. Then how to access the Internet resource becomes an important issue.

A typical searching principle comprises steps of connecting to Internet via a computer, accessing a searching page, keying in key-word, and searching by searching engine such as YAHOO, GOOGLE. Then the searching engine lists the results to the user, and user can choose proper item to download it, and then can save the data into chosen folder and file name.

However, the above-mentioned principle wastes lots of time and the user has to manage the download data separately. For a long leaving unused situation, the user is easy to forget the downloaded data and hard to recall it, which costs repeating operation add resource waste.

Further, different from personal computer, nowadays cellular phone, PDA, and developing electrical products are mostly combined with Internet application to access Internet on the go. But recent method is inconvenient to apply, due to the clumsy input and management. Therefore, generally the operation process of cellular phone and PDA suggests the user to download data via personal computer first, then transfer it to the electrical products via transmission line. More, for products like cellular phone or PDA, the demandable type of data is not various, such as graphic, ringing, or short film data. These data has specific format and is easy to be managed, which does not need complex searching process.

Therefore, the conventional methods of data searching, downloading, and filing are not convenient, and an improved method is desired.

### SUMMARY OF THE INVENTION

The invention is to provide a method of automatic filing of searching results, which automatically and accurately saves the searching results without user's complex command.

Another, the invention is to provide a method of automatic filing of searching results, which can be applied in electrical products with internet connecting function, such as computer, cellular phone, PDA, and etc.

The method of automatic filing of searching results comprises steps of connecting to Internet via electrical products such as computer, cellular phone, PDA, and etc by wireless or wire connection, entering searching engine such as YAHOO, GOOGLE and keying in keyword of data to be searched, processing search and listing searching results, choosing required data, then automatically downloading the required data and filing it in response to defined rules. The defined rules categorize data according to title, keyword, category, serial numbers of searching data, or according to size, date, and inventor of searching data. Also the defined rules designate apparatus, path, category, and title of filing process. And it can process crossover analysis with multi-defined rules to get more accurate results.

### BRIEF DESCRIPTION OF THE DRAWINGS

The drawings disclose an illustrative embodiment of the present invention which serves to exemplify the various advantages and objects hereof, and are as follows:

FIG. 1 is a perspective view of system structure of the invention; and

FIG. 2 is a flow chart of the invention.

### DETAILED DESCRIPTION OF THE PREFERRED EMBODIMENT

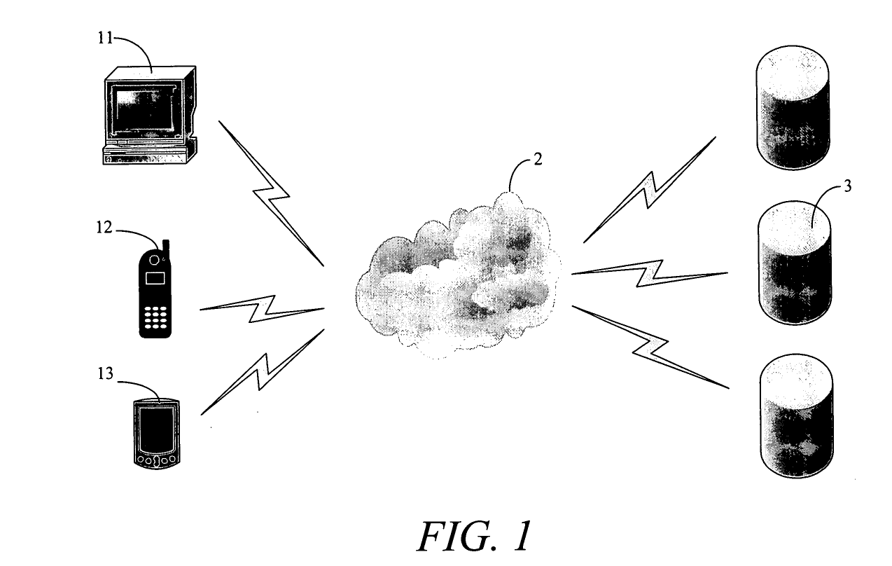

Referring to FIG. 1, the hardware of the invention comprises an apparatus being able to connect to Internet, such as computer 11, cellular phone 12, PDA 13, and etc. By connecting the apparatus to Internet 2, and processing search in a large number of data storing media connected with Internet, it can download searching results and store the results in the apparatus which sends out the searching request.

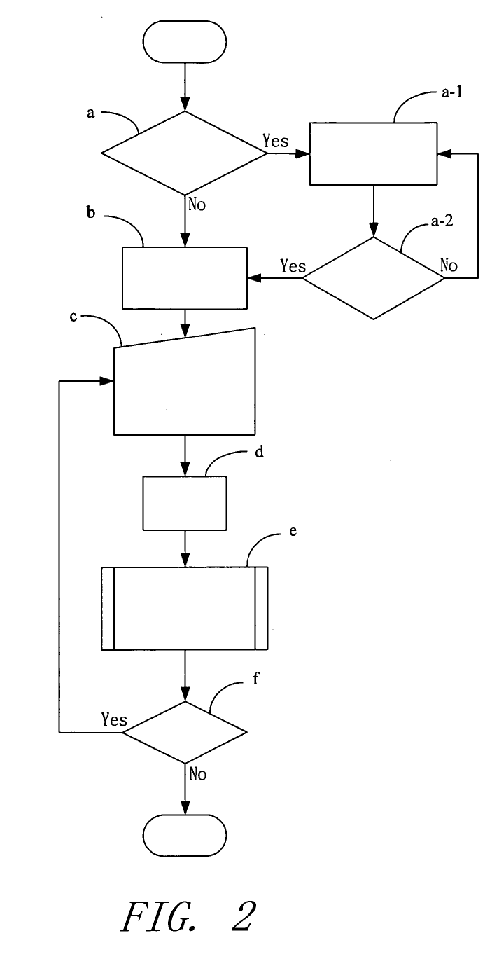

Referring to FIG. 2, the invention comprises steps of:

determining whether it is needed to change defined rules via apparatus operated by user, if it is needed, then processing step a-1 to change defined rules, otherwise processing step a-2 to confirm;

connecting the apparatus to Internet via wireless or wire connection;

processing search by keying in keyword in Internet searching engine such as YAHOO, GOOGLE, and listing searching results;

choosing required data from the searching results to be downloaded from Internet;

automatically filing the downloaded data; and

determining whether continuing to search, if affirmatively, going back to above search processing step again, otherwise finishing search.

The defined rules designate apparatus, path, category, and title of filing process. For example, it can use keying in title or keyword of data to determine title of saving folder or file, or it can use category of data such as graphic, imaging, and audio to automatically save downloaded data to relevant location. The method can efficiently manage data, and makes relevant media playing program easy to find the downloaded data and execute with the data. More, it can categorize the data according to serial numbers, size, date, or inventor of searching the data.

The defined rules can process crossover analysis with multi-defined rules to get more accurate results. For example, a same file name may comprise different versions with different accomplished time, and the data of different versions may be various, by applying multi-defined rules, it can get more accurate results and skip dispensable data.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A method of automatic filing of searching results, which comprises steps of:
connecting to Internet;
processing search, and listing searching result; and
choosing required data from the searching results to be downloaded from the Internet, and automatically filing the downloaded data;

2. The method of claim 1, wherein the step of connecting to the Internet applies a wireless or a wire connection via an apparatus being able to access the Internet.

3. The method of claim 2, wherein the apparatus is a computer, a cellular phone, or a PDA (personal digital assistant).

4. The method of claim 1, wherein the step of automatically filing the downloaded data comprises searching manner provided by a searching engine.

5. The method of claim 1, further comprising applying defined rules to determine an apparatus, path, category, and title of the downloaded data to be stored.

6. The method of claim 5, wherein the defined rules categorize data according to a title, a keyword, a category, serial numbers of the searching data, or according to a size, date, an inventor of the searching results.

7. The method of claim 5, wherein the defined rules are made by an Internet service provider or a client.

8. The method of claim 5, wherein the defined rules can be adjusted immediately according to a user's demand.
